(19) United States
(12) Patent Application Publication
(10) Pub. No.: US 2007/0091240 A1
(43) Pub. Date: Apr. 26, 2007

(54) Liquid crystal display and method of manufacturing the same

(75) Inventors: Tomonori Tanose, Yonago-shi (JP); Atsuyuki Hoshino, Nara (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/441,337

(22) Filed: May 26, 2006

(30) Foreign Application Priority Data
May 30, 2005 (JP) 2005-157586

(51) Int. Cl. G02F 1/1343; G02F 1/1333

(52) U.S. Cl. 349/139; 349/138

(57) ABSTRACT

A liquid crystal display is disclosed that includes a first substrate having a reflective layer; a second substrate having multiple pixels formed thereon, the pixels each having a color filter layer; and a liquid crystal layer sandwiched between the first and second substrates with a predetermined distance between the first and second substrates. Each of the pixels includes a reflective part to reflect light entering from the second substrate side by the reflective layer and a transmissive part to transmit light from the side of the first substrate facing away from the second substrate. An alignment control projection to control the alignment of liquid crystal molecules is provided in the reflective part of each of the pixels. The alignment control projection in the reflective part functions as a spacer to control the predetermined distance between the first and second substrates in at least one of the pixels.

### BACKGROUND OF THE INVENTION

1. Field of the Invention

The present invention generally relates to liquid crystal displays (LCDs) and methods of manufacturing the same, and more particularly to an LCD having a reflective layer and a method of manufacturing the same.

2. Description of the Related Art

Color LCDs are used in notebook personal computers, TVs, monitors, PDAs, projection projectors, and cellular phones. There is a rapid increase in the demand for LCDs, and the user's needs for LCDs are also diversified. In particular, the LCDs of portable electronic apparatuses such as notebook personal computers and PDAs are required to provide good visibility both in a dark environment, for example, indoors, and in a bright environment, for example, out of doors under sunlight. In order to meet such needs, transflective LCDs have been proposed (see, for example, Japanese Laid-Open Patent Application No. 2002-221716). The transflective LCD can function principally as a reflective LCD in a bright environment and function principally as a transmissive LCD in a dark environment. The transflective LCD has the advantage of low power consumption and a resultant longer use period in a bright environment, and accordingly, is best suited as an LCD for portable electronic equipment.

Vertically aligned (VA) LCDs, which are superior in viewing angle characteristics and display quality among LCDs, have been proposed (see, for example, Japanese Laid-Open Patent Application No. 11-242225). The VA LCD is characterized by having a vertical alignment film on each of the opposing surfaces of substrates and including a liquid crystal layer having negative dielectric anisotropy between the substrates. Further, the VA LCD has projections and/or slits for controlling the alignment of liquid crystal molecules on the substrates, thereby realizing excellent viewing angle characteristics and display quality (see, for example, Japanese Laid-Open Patent Application No. 2002-162629).

However, according to Japanese Laid-Open Patent Application No. 2002-162629, in addition to the projections for alignment control of liquid crystal molecules, there is provided a spacer for maintaining the gap between the substrates between which the liquid crystal layer is sandwiched. The spacer is disposed on a black matrix layer provided among pixels. Therefore, since it is impossible to narrow the black matrix layer, the aperture ratio in a pixel is restricted. On the other hand, the spacer can be provided in a pixel. However, this causes a problem in that the alignment of liquid crystal molecules around the spacer is disturbed so that display quality is degraded.

### SUMMARY OF THE INVENTION

Embodiments of the present invention may solve or reduce one or more of the above disadvantages.

In a preferred embodiment of the present invention, there are provided an LCD in which the above-described disadvantages are eliminated, and a method of manufacturing the same.

In a preferred embodiment of the present invention, there are provided a transflective LCD having a projection to function as a spacer and to control the alignment of liquid crystal molecules in a pixel, and a method of manufacturing the same.

According to one aspect of the present invention, there is provided a liquid crystal display including a first substrate having a reflective layer; a second substrate having a plurality of pixels formed thereon, the pixels each having a color filter layer; and a liquid crystal layer sandwiched between the first and second substrates with a predetermined distance between the first and second substrates, wherein each of the pixels includes a reflective part to reflect light entering from a side of the second substrate by the reflective layer and a transmissive part to transmit light from a side of the first substrate facing away from the second substrate; an alignment control projection to control alignment of liquid crystal molecules is provided in the reflective part of each of the pixels; and the alignment control projection in the reflective part functions as a spacer to control the predetermined distance between the first and second substrates in at least one of the pixels.

According to one embodiment of the present invention, an alignment control projection provided in a reflective part functions as a spacer. Therefore, it is possible to retain a predetermined distance between a first substrate and a second substrate. Further, the alignment control projection controls the alignment of its surrounding liquid crystal molecules. Accordingly, it is possible to maintain the display quality of the reflective part. Further, by appropriately selecting a pixel in which such an alignment control projection with the spacer function is to be formed, it is possible to prevent so-called foaming in a low-temperature environment and the problem of variations due to gravity.

According to another aspect of the present invention, there is provided a method of manufacturing a liquid crystal display, the liquid crystal display including a first substrate having a reflective layer; a second substrate having a plurality of pixels formed thereon, the pixels each having a color filter layer; and a liquid crystal layer sandwiched between the first and second substrates with a predetermined distance between the first and second substrates, wherein each of the pixels includes a reflective part to reflect light entering from a side of the second substrate by the reflective layer and a transmissive part to transmit light from a side of the first substrate facing away from the second substrate, the method including the steps of: (a) selectively forming the color filter layer on a transparent substrate; (b) selectively forming a transparent resin layer covering the color filter layer; and (c) forming an alignment control projection on the transparent resin layer, wherein step (a) forms the color filter layer in an area where the alignment control projection is to be formed in the reflective part in at least one of the pixels; and step (c) forms the alignment control projection on a surface of the transparent resin layer on which a convex part is caused to be formed by the color filter layer.

According to one embodiment of the present invention, in the process of selectively forming a color filter layer, the color filter layer is left in a position in a reflective part in which position an alignment control projection to function as a spacer is to be formed. As a result, a convex part is formed on the surface of a transparent resin layer covering the color filter layer. By forming the alignment control projection on the convex part, the end part of the alignment control projection protrudes to come into contact with a first substrate. Accordingly, it is possible to omit the process of forming a spacer without providing a new process. Accordingly, it is possible to reduce the number of processes and to simplify the manufacturing process, so that it is possible to reduce manufacturing costs.

Further, whether to provide the alignment control projection to function as a spacer in the reflective part may be determined by changing the pattern of a single mask in the process of selectively forming the color filter layer. Therefore, it is possible to easily change the proportion of alignment control projections to function as a spacer to the alignment control projections. Accordingly, in a design change accompanied by a change in the proportion of alignment control projections to function as a spacer, it is possible to reduce the time and cost necessary for the design change, so that it is possible to reduce manufacturing costs.

Thus, according to embodiments of the present invention, it is possible to provide a transflective LCD having a projection to function as a spacer and to control the alignment of liquid crystal molecules in a pixel, and a method of manufacturing the same.

### BRIEF DESCRIPTION OF THE DRAWINGS

Other objects, features and advantages of the present invention will become more apparent from the following detailed description when read in conjunction with the accompanying drawings, in which:

FIG. 1 is a schematic diagram showing a liquid crystal display (LCD) according to a first embodiment of the present invention;

FIG. 2 is an equivalent circuit diagram of a pixel structure formed on a TFT substrate of the LCD according to the first embodiment of the present invention;

FIG. 3 is a partial plan view of the LCD according to the first embodiment of the present invention;

FIG. 4 is an enlarged plan view of a first pixel according to the first embodiment of the present invention;

FIG. 5 is a cross-sectional view of the first pixel of FIG. 4 taken along the line A-A according to the first embodiment of the present invention;

FIG. 6 is a cross-sectional view of the first pixel of FIG. 4 taken along the line B-B according to the first embodiment of the present invention;

FIG. 7 is an enlarged plan view of a second pixel according to the first embodiment of the present invention;

FIG. 8 is a cross-sectional view of the second pixel shown in FIG. 7 taken along the line C-C according to the first embodiment of the present invention;

FIGS. 9A through 9E are diagrams showing a method of manufacturing the LCD according to the first embodiment of the present invention;

FIG. 10 is a plan view of a first variation of the second pixel according to the first embodiment of the present invention;

FIG. 11 is a plan view of a second variation of the second pixel according to the first embodiment of the present invention;

FIG. 12 is a cross-sectional view of part of a first pixel of an LCD according to a second embodiment of the present invention; and

FIG. 13 is a cross-sectional view of part of a second pixel of the LCD according to the second embodiment of the present invention.

### DETAILED DESCRIPTION OF THE PREFERRED EMBODIMENTS

A description is given below, with reference to the accompanying drawings, of embodiments of the present invention.

### First Embodiment

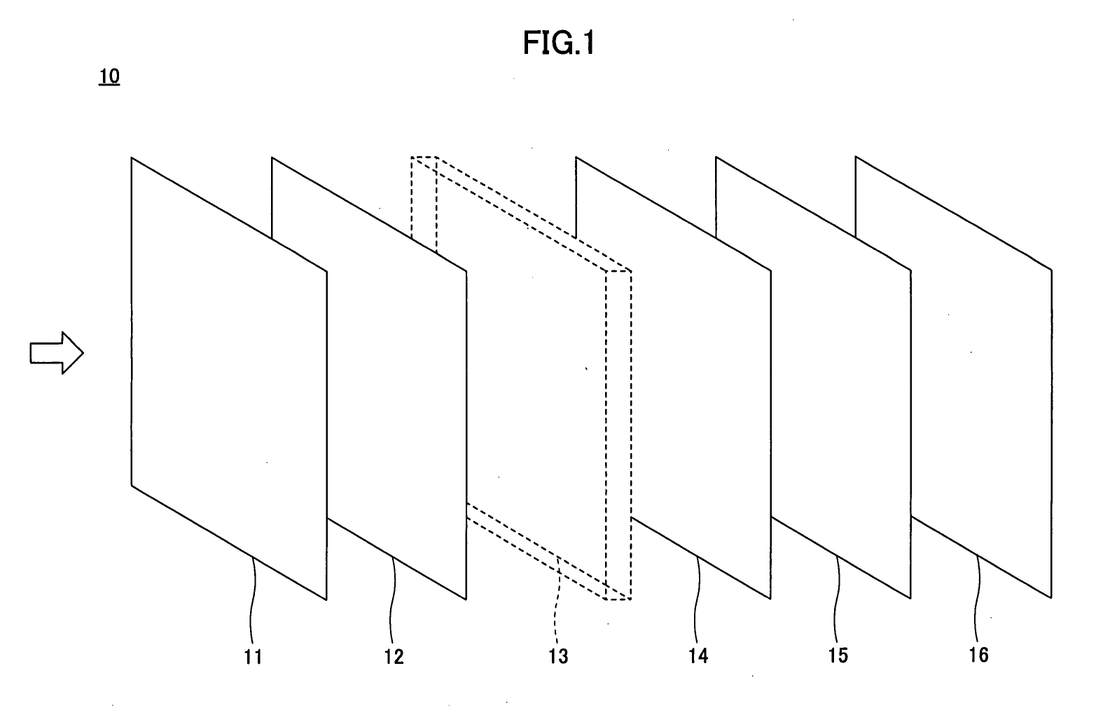

FIG. 1 is a schematic diagram showing a liquid crystal display (LCD) 10 according to a first embodiment of the present invention. In FIG. 1, the arrow indicates a viewing direction.

Referring to FIG. 1, the LCD 10 includes a polarizing plate 11, a color filter (CF) substrate 12 on which color filters are provided, a liquid crystal layer 13, a thin film transistor (TFT) substrate 14, a polarizing plate 15, and a backlight unit 16, which are stacked in this order from the viewing side.

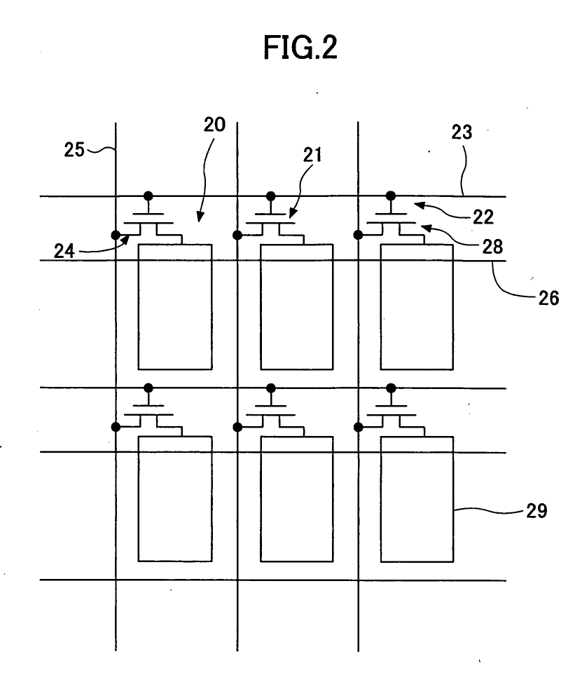

FIG. 2 is an equivalent circuit diagram of a pixel structure formed on the TFT substrate 14. Referring to FIG. 2, one TFT 21 is provided in each of pixel areas 20 disposed in a matrix manner. The gate of each TFT 21 extends laterally in FIG. 2, and is connected to a corresponding one of multiple gate bus lines 23 disposed parallel to one another. Further, a drain 24 of each TFT 21 extends vertically in FIG. 2, and is connected to a corresponding one of multiple drain bus lines 25 disposed parallel to one another. Further, in each pixel area 20, a storage capacitance bus line 26 is formed parallel to the corresponding gate bus lines 23. A source 28 of each TFT 21 is connected to a pixel electrode 29 of a light-transmissive material provided in the corresponding pixel area 20.

Referring back to FIG. 1, the two polarizing plates 11 and 15 are disposed so that their respective absorption axes are perpendicular to each other. The liquid crystal layer 13 is sandwiched between the CF substrate 12 and the TFT substrate 14. A liquid crystal is enclosed in the liquid crystal layer 13 by sealing its periphery with a sealing material (not graphically illustrated). The liquid crystal has, for example, negative dielectric anisotropy. In this case, the LCD 10 is normally black, that is, when no voltage is applied between the counter electrodes on the CF substrate 12 and the pixel electrodes 29 on the TFT substrate 14, the LCD 10 looks black.

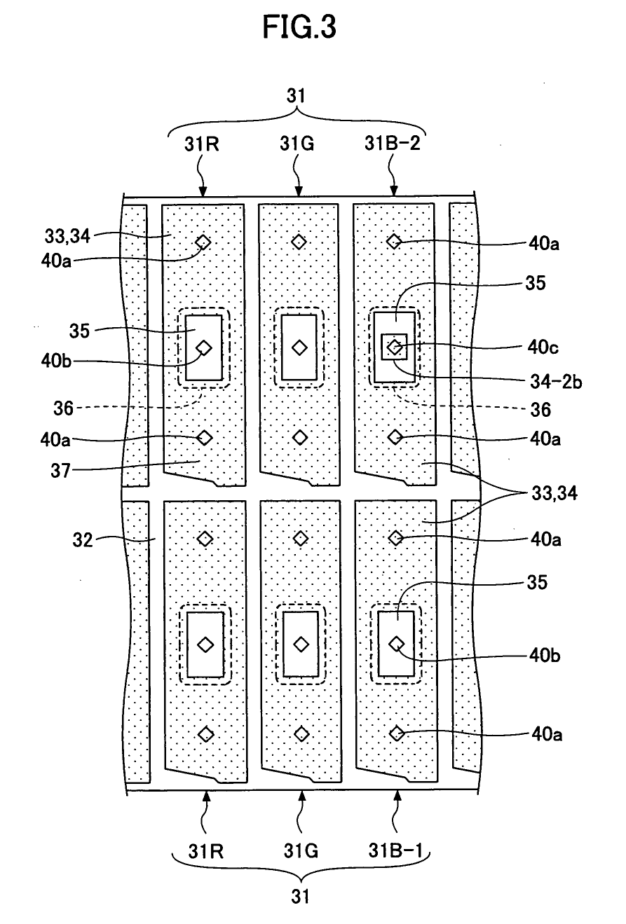

FIG. 3 is a partial plan view of the LCD 10, showing part of the CF substrate 12 viewed from the viewing side.

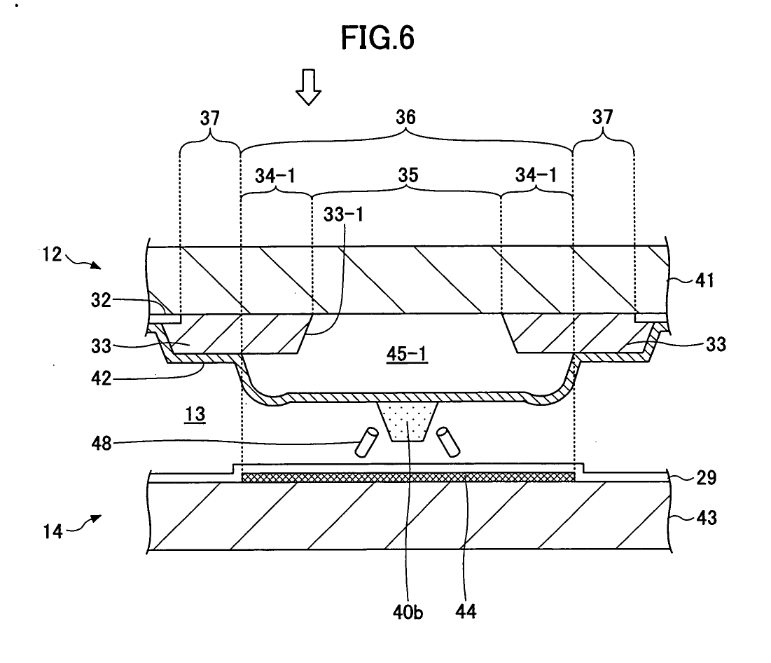

Referring to FIG. 3 in addition to FIG. 1, the CF substrate 12 includes pixels 31R, 31G, and 31B (31B-1 and 31B-2) of the three colors red (R), green (G), and blue (B) arranged in a matrix manner, and a black matrix layer 32 provided among those pixels 31R, 31G, and 31B (31B-1 and 31B-2). Hereinafter, the pixels 31R, 31G, and 31B (31B-1 and 31B-2) may also be referred to as “pixels 31” when there is no need to distinguish between them. In each pixel 31, a colored area 34 colored by a color filter layer 33 and a color-free area 35 where the color filter layer 33 is not provided are formed. The color-free area 35 is formed around the center of the pixel 31. Further, multiple reflective layers 44 (FIG. 6) are provided in the TFT substrate 14 opposing the pixels 31. Each reflective layer 44 reflects light entering from the viewing side through the CF substrate 12 and the liquid crystal layer 13, and lets the reflected light out to the viewing side again through the liquid crystal layer 13 and the CF substrate 12. An area included in the reflective layer 44 when viewed from the viewing side is referred to as a reflective part 36. The reflective part 36 is formed to be greater than the color-free area 35 with its periphery overlapping the colored area 34. Further, the area outside the reflective part 36 in the pixel 31 is a transmissive part 37, which is an area through which light passes from the rear side of the TFT substrate 14. Since the color filter layer 33 is provided in the transmissive part 37, the transmissive part 37 is a colored area. Alignment control projections 40a through 40c are provided in the corresponding pixels 31.

The first and second blue pixels 31B-1 and 31B-2 are different from each other in the structure of the vicinity of the center. The first blue pixel 31B-1 has the color-free area 35 in its substantial center, and the alignment control projection 40b is provided in the center of the color-free area 35. On the other hand, the second blue pixel 31B-2 has the color-free area 35 in its substantial center, and further includes a colored area 34-2b in the center of the color-free area 35. The alignment control projection 40c is provided in the colored area 34-2b. As is described in detail below, the alignment control projection 40c of the second blue pixel 31B-2 also functions as a spacer to control the gap between the CF substrate 12 and the TFT substrate 14.

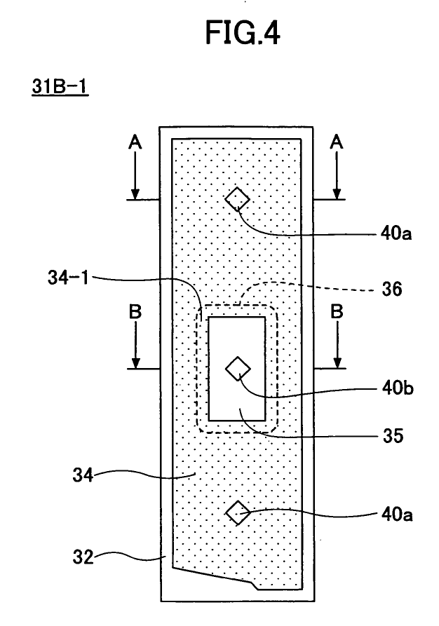

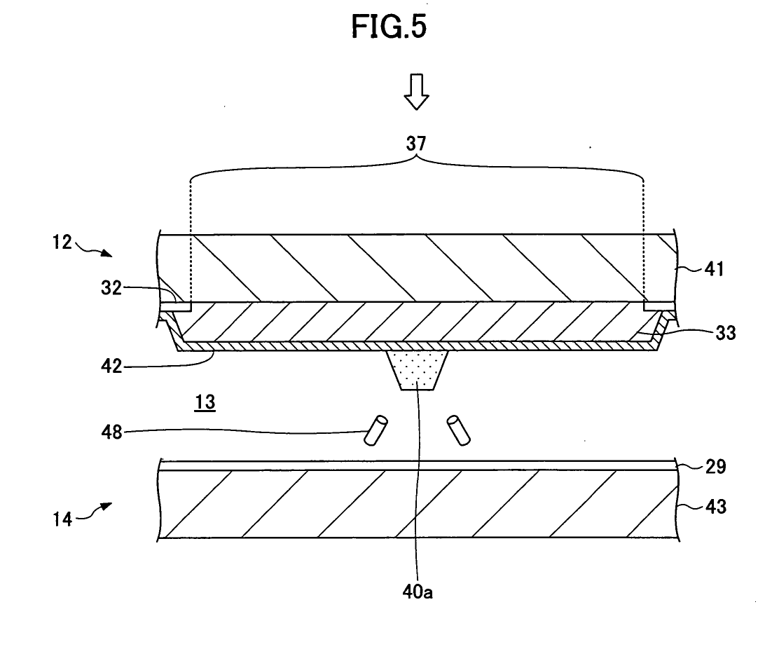

FIG. 4 is an enlarged plan view of the first blue pixel 31-B1. FIG. 5 is a cross-sectional view of the first blue pixel 31-B1 of FIG. 4 taken along the line A-A. FIG. 6 is a cross-sectional view of the first blue pixel 31-B1 of FIG. 4 taken along the line B-B.

Referring to FIGS. 4 and 5, in the CF substrate 12, the black matrix layer 32, the color filter layer 33, and a counter electrode 42 covering the black matrix layer 32 and the color filter layer 33 are provided under a glass substrate 41.

The black matrix layer 32 is formed of a light-blocking material such as a Cr film or a Cr-based alloy. The black matrix layer 32 is formed between each adjacent two of the pixels 31 so as to produce the effect of increasing contrast. Although not graphically illustrated, the black matrix layer 32 is formed above the gate bus lines 23 and the drain bus lines 25 formed on the TFT substrate 14 shown in FIG. 2.

The color filter layer 33 is formed of resin in which coloring materials or pigments are dispersed. It is preferable to employ a photosensitive resin material for the color filter layer 33 in terms of easiness of patterning the color filter layer 33 in the manufacturing process of the LCD 10.

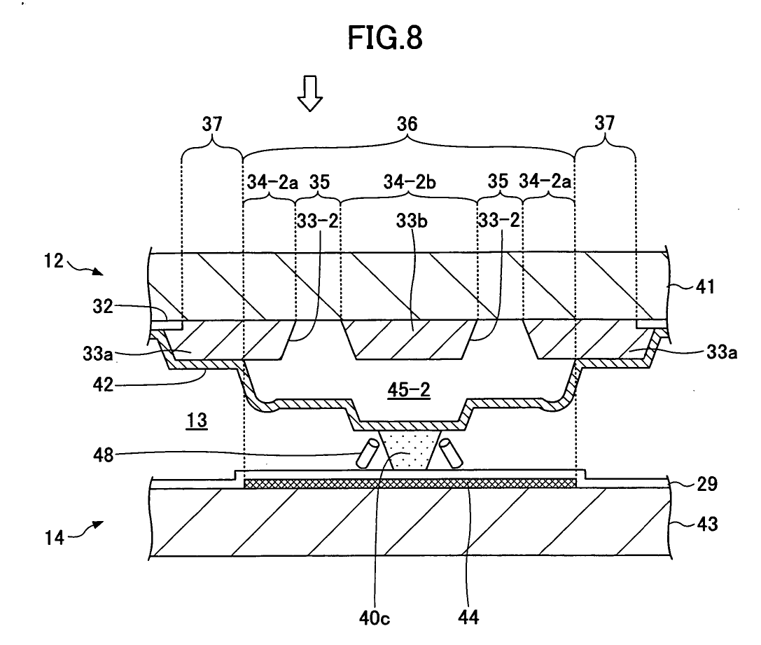

The counter electrode 42 is a continuous film covering the entire surface of the black matrix layer 32 and the color filter layer 33. The counter electrode 42 also continuously covers the surfaces of the color filter layers 33 of the red and green pixels 31R and 31G and the surface of transparent resin layers 45-1 and 45-2 shown in FIGS. 6 and 8. The counter electrode 42 is formed of a light-transmissive conductive material such as ITO (Indium Tin Oxide).

On the other hand, the pixel electrodes 29 formed of a light-transmissive conductive material such as ITO are formed on a glass substrate 43 in the TFT substrate 14 opposing the CF substrate 12. In FIG. 5, graphical representation of a TFT array is omitted.

Each alignment control projection 40a is provided on the counter electrode 42 on the corresponding color filter layer 33. The alignment control projection 40a has a diamond planar shape and three-dimensionally has a truncated pyramid shape. That is, the alignment control projection 40a has diamond top and bottom faces and trapezoidal side faces. Alternatively, the alignment control projection 40a may have a triangular planar shape and three-dimensionally have a truncated pyramid shape. The alignment control projection 40a has the function of controlling the alignment of liquid crystal molecules 48. The alignment control projection 40a is, for example, 2 μm in height. The end part of the alignment control projection 40a is prevented from coming into contact with the corresponding pixel electrode 29 on the TFT substrate 14.

The alignment control projections 40a are not limited in material in particular as long as the material is resin. It is preferable, however, to use a photosensitive resin material in terms of easiness of patterning in the manufacturing process of the LCD 10. Examples of the photosensitive resin material include a positive novolac material.

Referring to FIGS. 4 and 6, in the first blue pixel 31B-1, the black matrix layer 32 and the color filter layer 33 are provided under the glass substrate 41. An opening 33-1 is provided in the sidewise center part of the color filter layer 33 so as to pass through the color filter layer 33 to expose the glass substrate 41. Further, the transparent resin layer 45-1 is provided on the glass substrate 41 in the opening 33-1 and on part of the color filter layer 33 around the opening 33-1. The transparent resin layer 45-1 is provided over the entire reflective part 36.

The transparent resin layer 45-1 is not limited in material in particular as long as the material is a colorless, light-transmissive resin material. It is preferable, however, to use a photosensitive material in terms of easiness of patterning in the manufacturing process of the LCD 10. Examples of the photosensitive material include a positive acryl material. The area where the transparent resin layer 45-1 is in contact with the glass substrate 41 serves as the color-free area 35.

Further, the alignment control projection 40b is provided on the counter electrode 42 covering the surfaces of the color filter layer 33 and the transparent resin layer 45-1. The end part of the alignment control projection 40b is separated from the corresponding pixel electrode 29 on the TFT substrate 14.

On the other hand, in the TFT substrate 14, the reflective layer 44 is provided between the glass substrate 43 and the pixel electrode 29 below the transparent resin layer 45-1 and the alignment control projection 40b. The reflective layer 44 forms the reflective part 36. The reflective layer 44 reflects incoming light passing through the color filter layer 33 or the transparent resin layer 45-1 and the liquid crystal layer 13 from the viewing side, and lets the reflected light out to the viewing side. In FIG. 6, the transmissive part 37 is formed on each lateral side of the reflective part 36.

The reflective layer is not limited in material in particular as long as the material is a metal material having such thickness as to provide good visible light reflectance. For example, the reflective layer 44 is formed of a layered body of a Ti film (100 nm in thickness) and an Al film (100 nm in thickness) successively stacked from the glass substrate 43 side.

In the reflective part 36, the transparent resin layer 45-1 is formed on the surface of the glass substrate 41 so as to be thicker than the color filter layer 33. The thickness of the transparent resin layer 45-1 is determined so that the liquid crystal layer 13 of the reflective part 36 is substantially half as thick as the transmissive part 37. That is, the thickness of the transparent resin layer 45-1 is substantially equal to the sum of the thickness of the color filter layer 33 and the thickness equivalent to the half of the distance between the counter electrode 42 and the pixel electrode 29 in the transmissive part 37. This is for causing light entering from outside to receive the same refraction from the liquid crystal layer 13 as light passing through the transmissive part 37 because the light entering from outside passes through the liquid crystal layer 13 twice in the reflective part 36. The liquid crystal layer 13 is, for example, 7 μm in the transmissive part 37 and 3.5 μm in the reflective part 36.

Further, in the reflective part 36, part of the light entering from outside passes through the color filter layer 33 (a colored area 34-1) to be colored, so that colored light is emitted to the viewing side. With respect to light passing through the transparent resin layer 45-1, that is, the color-free area 35, white light is emitted to the viewing side. Further, the light passing through the color filter layer 33 twice in the reflective part 36 (colored light) is darker than the light emitted from the transmissive part 37, which light passes through the color filter layer 33 only once. However, since the white light and the colored light from the reflective part 36 are observed in a mixture, the color density of the reflective part 36 becomes low (bright). For example, reducing the proportion of the area of the color-free area 35 in the reflective part 36 increases the color density of the light from the entire reflective part 36 so that the color density of the reflective part 36 becomes higher (darker) than the color density of the transmissive part 37. Accordingly, by appropriately setting the area ratio of the colored area 34-1 to the color-free area 35, it is possible to prevent the reflective part 36 from being higher (darker) in color density than the transmissive part 37.

The alignment control projection 40b is formed of the same material as the alignment control projection 40a shown in FIG. 5, and has the same shape as the alignment control projection 40a. Further, the alignment control projection 40b is formed to have substantially the same height as the alignment control projection 40a. The end part of the alignment control projection 40b is closer to the pixel electrode 29 than the alignment control projection 40a shown in FIG. 5 is by the difference in thickness between the transparent resin layer 45-1 and the color filter layer 33. The alignment control projection 40b is out of contact with the pixel electrode 29, and does not have the function of a spacer.

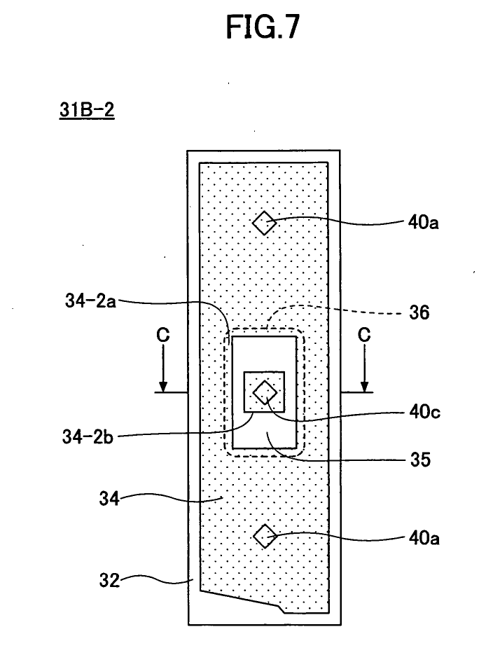

FIG. 7 is an enlarged plan view of the second blue pixel 31B-2. FIG. 8 is a cross-sectional view of the second blue pixel 31B-2 shown in FIG. 7 taken along the line C-C. Referring to FIGS. 7 and 8, in the second blue pixel 31B-2, the black matrix layer 32 and color filter layers 33a and 33b are provided under the glass substrate 41. Unlike the color filter layer 33 shown in FIG. 6, the color filter layer 33b is formed in the sidewise center part of the second blue pixel 31B-2. An opening 33-2 is provided around the color filter layer 33b so as to expose the glass substrate 41. Further, the transparent resin layer 45-2 is provided on the color filter layer 33b, the surface of the glass substrate 41 in the opening 33-2, and part of the color filter layer 33a around the opening 33-2. The transparent resin layer 45-2 is formed of the same material as the transparent resin layer 45-1 shown in FIG. 6, and has substantially the same thickness as the transparent resin layer 45-1. However, since the center part of the transparent resin layer 45-2 is formed on the color filter layer 33b, the shape of the color filter layer 33b is substantially transferred to the transparent resin layer 45-2, so that a convex part is formed in the center part thereof. The alignment control projection 40c is formed on the counter electrode 42 on the convex part. The end part of the alignment control projection 40c is in contact with the surface of the corresponding pixel electrode 29.

On the other hand, in the TFT substrate 14, the reflective layer 44 is provided between the glass substrate 43 and the pixel electrode 29 below the transparent resin layer 45-2.

In the second blue pixel 31B-2, the reflective part 36 has the colored area 34-2b in its center part in addition to a colored area 34-2a in its periphery. It is preferable that the area ratio of the colored area 34-2a and the colored area 34-2b to the color-free area 35 be substantially the same as the area ratio of the colored area 34-1 to the color-free area 35 of the first blue pixel 31B-1 shown in FIG. 6. This makes it possible to make the first blue pixel 31B-1 and the second blue pixel 31B-2 substantially equal in color density. As a result, it is possible to make color density uniform between pixels of the same color. In order to thus determine the area ratio of the colored area 34-2a and the colored area 34-2b together to the color-free area 35, for example, the area of the colored area 34-2a in the periphery of the reflective part 36 is smaller than the area of the colored area 34-1 in the periphery of the reflective part 36 of the first blue pixel 31B-1 by the area of the colored area 34-2b.

The alignment control projection 40c has substantially as the same shape and height as the alignment control projections 40a and 40b shown in FIGS. 5 and 6, respectively. The alignment control projection 40c is provided on the transparent resin layer 45-2 stacked on the color filter layer 33 to have a convex part formed in its center part. The alignment control projection 40c projects more toward the TFT substrate 14 side than the alignment control projection 40b shown in FIG. 6 by the height of this convex part. As a result, the end part of the alignment control projection 40c comes into contact with the surface of the pixel electrode 29. That is, the alignment control projection 40c controls the gap between the CF substrate 12 and the TFT substrate 14, having the function of a spacer. At the same time, the alignment control projection 40c controls the alignment of surrounding liquid crystal molecules, so that the reflective part 36 has good display characteristics. In consequence, the reflective part 36 has better display characteristics than in the case of being simply provided with a spacer.

Further, providing the alignment control projection 40c having the spacer function in the reflective part 36 eliminates the necessity of providing a spacer in the area of the black matrix layer 32. Therefore, it is possible to reduce the area of the black matrix layer 32. As a result, it is possible to increase the pixel aperture ratio.

Further, it is possible to determine spacer density by appropriately setting the ratio of the second blue pixels 31B-2 having the alignment control projections 40c with the spacer function to the first blue pixels 31B-1 having the alignment control projections 40b without the spacer function among multiple blue pixels formed in the LCD 10. This makes it possible to prevent occurrence of problems such as so-called foaming in a low temperature environment and chromaticity change due to variations resulting from gravity. Foaming in a low temperature environment refers to the following phenomenon. That is, in the case of heat shrinkage of a liquid crystal in a low temperature environment, if the spacer density is too high, a CF substrate and a TFT substrate cannot follow the heat shrinkage of the liquid crystal layer because the distance between the CF and TFT substrates is controlled, so that a gap is formed between the liquid crystal layer and each substrate so as to look like a bubble. Further, chromaticity change due to variations resulting from gravity refers to the following phenomenon. That is, when an LCD is used in a vertical position in the case of an excessively low spacer density, a liquid crystal gradually moves downward because of gravity, so that the liquid crystal layer becomes thick on the lower side, thus causing a change in the chromaticity of a display screen.

In the above description, the second blue pixel 31B-2 is described as having the alignment control projection 40c with the spacer function. Alternatively, a red or green pixel may have the alignment control projection 40c with the spacer function.

According to the LCD 10 according to the first embodiment, the alignment control projection 40c provided in the reflective part 36 of a pixel also functions as a spacer to control the gap between the CF substrate 12 and the TFT substrate 14. At the same time, since the alignment control projection 40c can control the alignment of its surrounding liquid crystal, the reflective part 36 has good display characteristics. As a result, it is possible to establish agreement in display characteristics such as color density and transmissivity with a pixel of the same color in which the reflective part 36 is provided with the alignment control projection 40b, which does not function as a spacer. In consequence, it is possible to make these characteristics uniform in a display area, so that it is possible to realize an LCD of good display quality.

Next, a description is given of a method of manufacturing the LCD 10 according to the first embodiment.

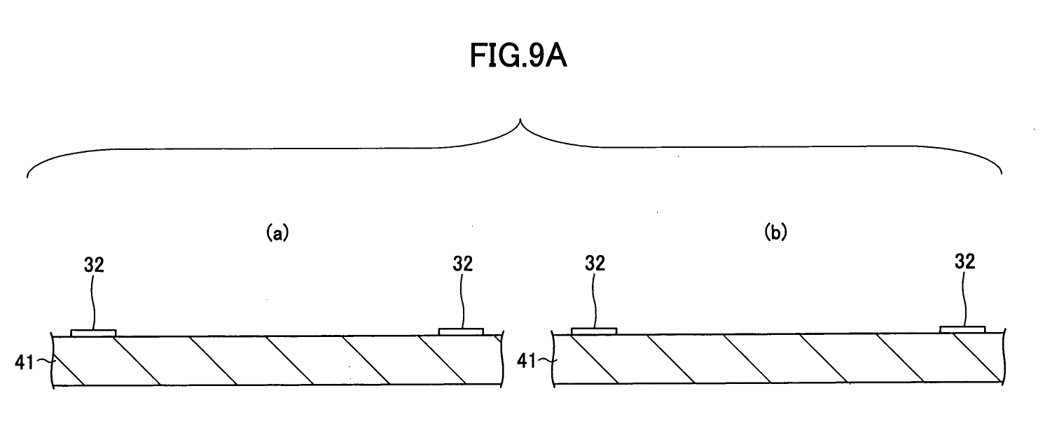

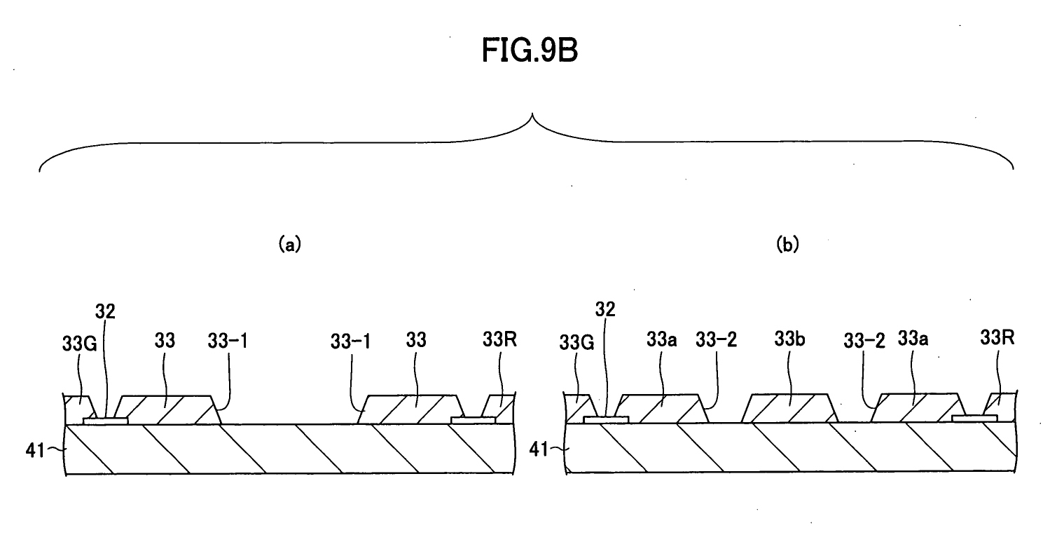

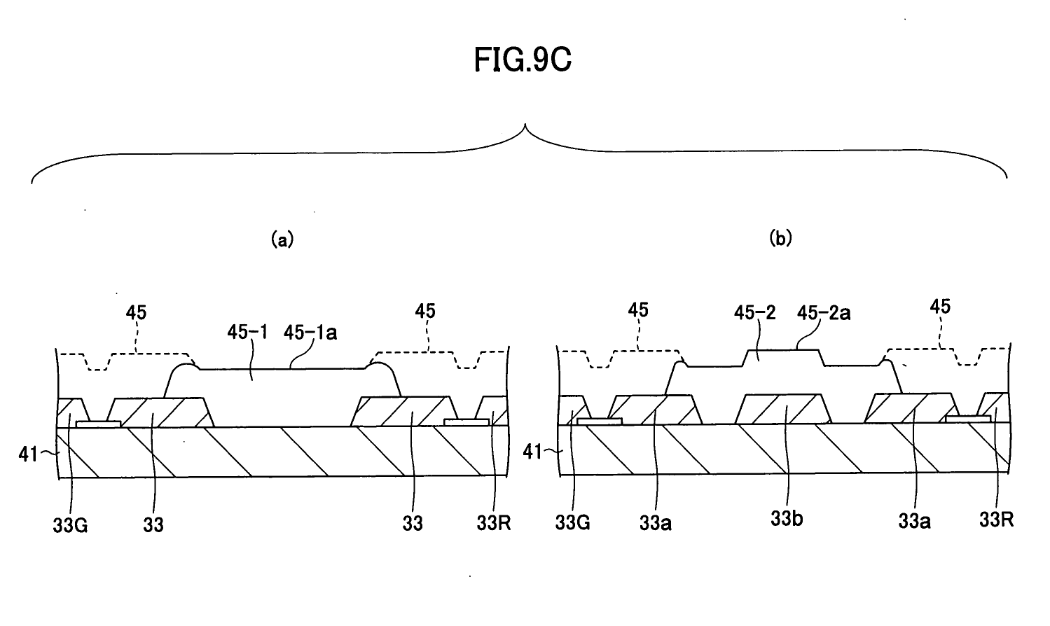

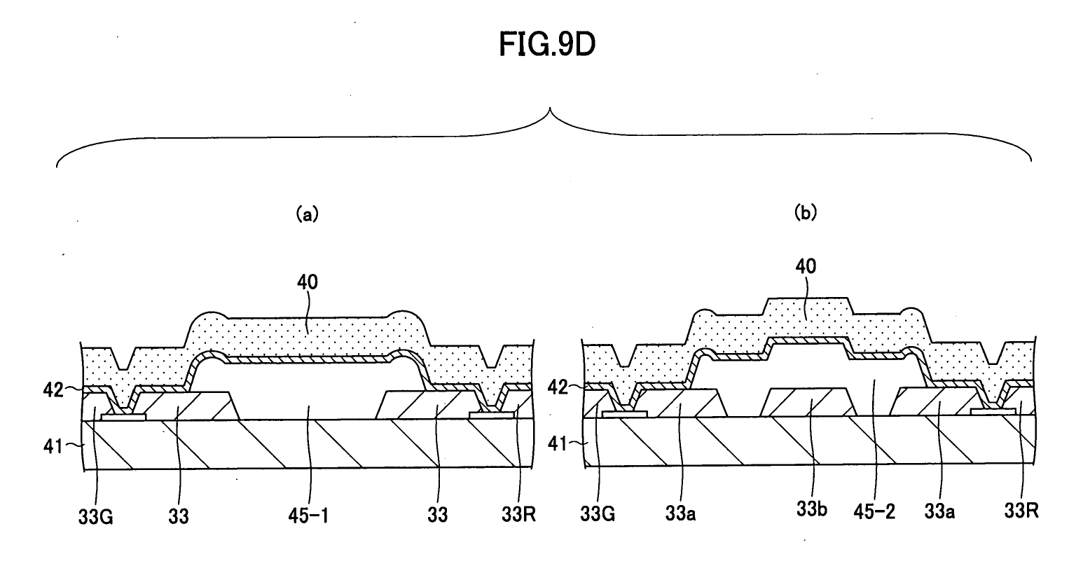

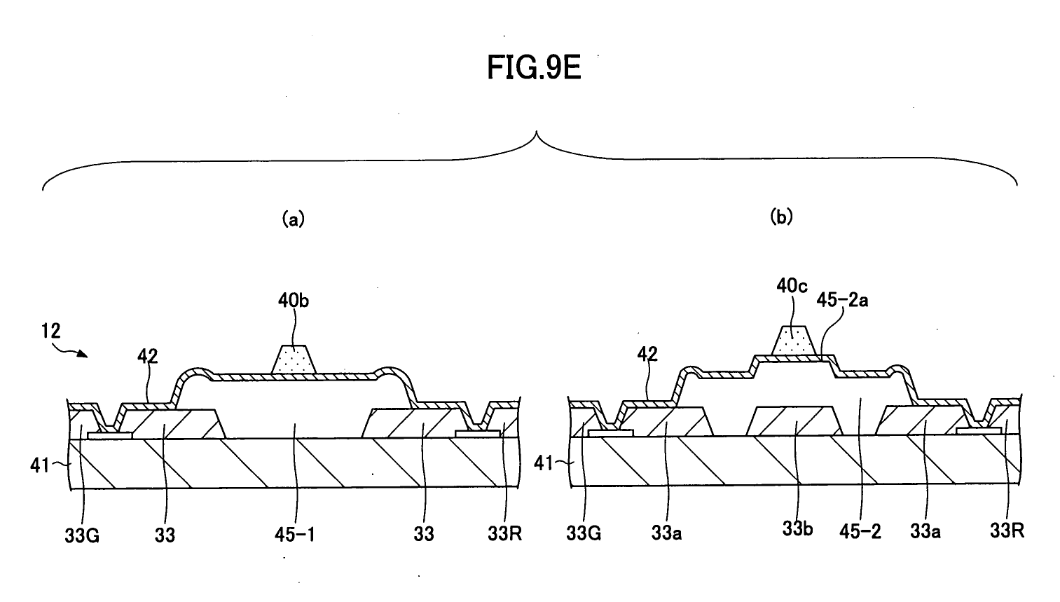

FIGS. 9A through 9E are diagrams showing a process of manufacturing the LCD 10 according to the first embodiment. In FIGS. 9A through 9E, (a) shows a cross-sectional view at the same position as the cross-sectional view of the first blue pixel 31B-1 of FIG. 6, and (b) shows a cross-sectional view at the same position as the cross-sectional view of the second blue pixel 31B-2 of FIG. 8. A detailed description is given below of a process of manufacturing the CF substrate 12.

First, in the process of FIG. 9A, the black matrix layer 32 is formed into a predetermined shape on the glass substrate 41 of the CF substrate 12. Specifically, a Cr film covering the entire surface of the glass substrate 41 is formed by sputtering so as to be, for example, 100 nm in thickness. Further, a resist film covering the Cr film is formed to be patterned into a predetermined shape by photolithography. Further, the Cr film is etched with the patterned resist film serving as a mask, and then the resist film is removed. Thus, the patterned black matrix layer 32 is obtained.

Next, in the process of FIG. 9B, red color filter layers 33R, green color filter layers 33G, and blue color filter layers 33B are formed. The respective manufacturing processes of the color filter layers 33R, 33G, and 33B are substantially the same. A description is given below of a process of manufacturing the blue color filter layers 33.

In the process of FIG. 9B, the color filter layers 33, 33a, and 33b having the openings 33-1 and 33-2 exposing the glass substrate 41 are formed. Specifically, a blue resist film of a photosensitive pigment dispersed type is formed on the glass substrate 41 and the black matrix layer 32 by coating so as to be, for example, 1.5 μm in thickness. Further, the blue resist film is exposed using a mask on which a predetermined pattern is formed, and each of development and post exposure bake is performed, thereby forming the color filter layers 33, 33a, and 33b. In this exposure, different patterns are formed for the parts shown in (a) and (b). That is, in the part shown in (a), the opening 33-1 is formed so that the color filter layer 33 does not remain in the sidewise center part. Meanwhile, in the part shown in (b), the opening 33-2 is formed around the color filter layer 33b so that the color filter layer 33b remains in the sidewise center part. The red and green color filter layers 33R and 33G are also formed in the same manner as the first blue pixel 31B-1 shown in (a).

Next, in the process of FIG. 9C, the transparent resin layers 45-1 and 45-2 are formed selectively on the structure of FIG. 9B. Specifically, a positive acryl resin film 45 of, for example, 3.5 μm in thickness is formed by coating so as to cover the surface of the structure of FIG. 9B. The surface of the positive acryl resin film 45 has substantially the same shape as the surfaces of the color filter layers 33, 33a, and 33b and the glass substrate 41 thereunder. Further, the positive acryl resin film 45 is exposed using a mask on which a predetermined pattern is formed, and each of development and post exposure bake is performed, thereby forming the transparent resin layers 45-1 and 45-2. Other photosensitive transparent resin materials may be employed in place of the positive acryl resin film 45.

As shown in (a) of FIG. 9C, the color filter layer 33 is not formed under the transparent resin layer 45-1 except for its periphery. Therefore, a surface 45-1a of the transparent resin layer 45-1 is substantially flat. On the other hand, as shown in (b) of FIG. 9C, the color filter layer 33b is formed under the transparent resin layer 45-2. Therefore, a convex part 45-2a is formed in the center part of the surface of the transparent resin layer 45-2. Thus, the transparent resin layers 45-1 and 45-2 different in surface shape are simultaneously formed in the process of FIG. 9C.

Next, in the process of FIG. 9D, ITO of, for example, 150 nm in thickness is formed by sputtering so as to cover the entire surface of the structure of FIG. 9C, thereby forming the counter electrode 42.

Further, in the process of FIG. 9D, for example, a positive novolac resin layer 40 is formed on the counter electrode 42 by coating so as to be 2.0 μm in thickness. The surface shape of the structure of FIG. 9C under the positive novolac resin layer 40 is substantially transferred to the surface of the positive novolac resin layer 40.

Next, in the process of FIG. 9E, the alignment control projections 40b and 40c are formed. Specifically, the positive novolac resin layer 40 is exposed using a mask on which a predetermined pattern is formed, and each of development and post exposure bake is performed, thereby forming the alignment control projections 40b and 40c. The alignment control projection 40b shown in (a) and the alignment control projection 40c shown in (b) themselves are substantially equal in height (vertical dimension). However, the alignment control projection 40c has a greater height from the surface of the glass substrate 41 than the alignment control projection 40b by the height of the convex part 45-2a, which is substantially the same as the thickness (1.5 μm) of the color filter layer 33b. The alignment control projections 40b and the alignment control projections 40c may have substantially the same or different sidewise sizes depending on exposure methods or mask patterns. Further, by using different mask patterns in forming the alignment control projections 40b and 40c, it is possible to form the alignment control projections 40b and 40c into different planar shapes such as a triangular shape and a rectangular shape.

Next, although not graphically illustrated, a vertical alignment film covering the surface of the structure of FIG. 9E is formed if necessary. Thereby, the CF substrate 12 is formed.

In the above description, drawings of a manufacturing process corresponding to the cross-section of FIG. 5 are omitted. However, the drawings are substantially the same as those of (a) of FIGS. 9A through 9E except that the opening part 33-1 is not provided in the color filter layer 33 shown in FIG. 9B and that the transparent resin layer 45-1 shown in FIG. 9C is not formed. Further, the alignment control projections 40a are formed simultaneously with the other alignment control projections 40b and 40c.

Further, a known method may be employed for a process of manufacturing the TFT substrate 14. A TFT array, reflective layers of a predetermined pattern, and pixel electrodes are formed on a glass substrate, thereby forming the TFT substrate 14.

Next, the thus obtained CF substrate 12 and TFT substrate 14 are stuck together using a sealing material. As a result, the end part of the alignment control projection 40c shown in (b) of FIG. 9E comes into contact with the surface of the TFT substrate 14, so that the alignment control projection 40c controls the gap between the CF substrate 12 and the TFT substrate 14. That is, the alignment control projection 40c functions as a spacer. The end part of the alignment control projection 40b shown in (a) of FIG. 9E is lower than that of the alignment control projection 40c so as to be out of contact with the surface of the TFT substrate 14. Thus, the alignment control projection 40b does not function as a spacer.

Further, for example, a liquid crystal having negative dielectric anisotropy is injected and sealed into the gap between the CF substrate 12 and the TFT substrate 14. Thereby, the graphically illustrated LCD 10 according to the first embodiment is completed.

In the manufacturing method according to the first embodiment, instead of separately providing a process of forming a spacer, alignment control projections to function as a spacer are formed simultaneously in the process of alignment control projections. This is because by leaving the color filter layer 33b in the position where the alignment control projection 40c to function as a spacer is to be formed in the process of forming the color filter layer openings 33-1 and 33-2, the convex part 45-2a is formed on the surface of the transparent resin layer 45-2 covering the color filter layer 33b so as to cause the alignment control projection 40c to project. Accordingly, it is possible to omit a process of forming a spacer, while there is no new process to be added. Therefore, it is possible to reduce the number of steps and to simplify the manufacturing process. As a result, it is possible to reduce manufacturing costs.

Further, in the case of changing the density of alignment control projections to function as a spacer, that is, spacer density, it is only necessary to change the pattern of a single mask in the process of forming the openings 33-1 and 33-2 by patterning a color filter layer. Accordingly, it is possible to change spacer density with ease, and to reduce both manufacturing cost and time for a design change.

Further, the area ratio of a colored area to a color-free area is determined using the above-described mask. Accordingly, it is possible to simultaneously change the color densities of a first color pixel and a second color pixel, so that it is possible to further reduce manufacturing costs.

Further, in order to match the color density of a reflective part with the color density of a transmissive part, the conventional manufacturing method includes the process of making a color filter layer thinner in the reflective part than in the transmissive part. However, in the manufacturing method according to the first embodiment, with respect to the color density of the reflective part 36, the area ratio of a colored area to a color-free area is adjusted with a mask for patterning a color filter layer. This obviates the necessity of the conventional film thinning process, so that it is possible to simplify the manufacturing process.

Next, a description is given of a variation of the second blue pixel 31B-2 shown in FIG. 7.

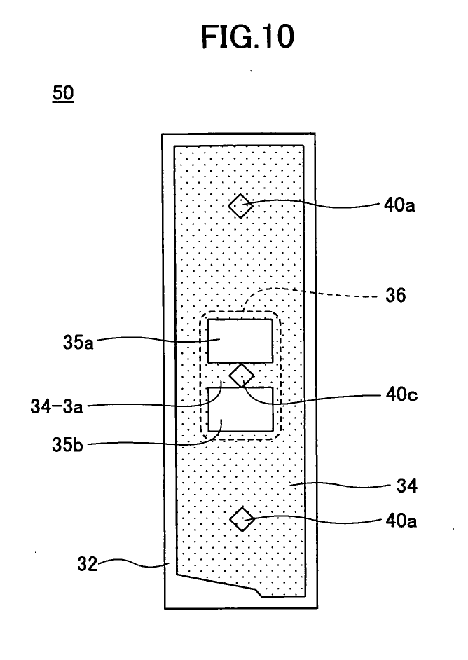

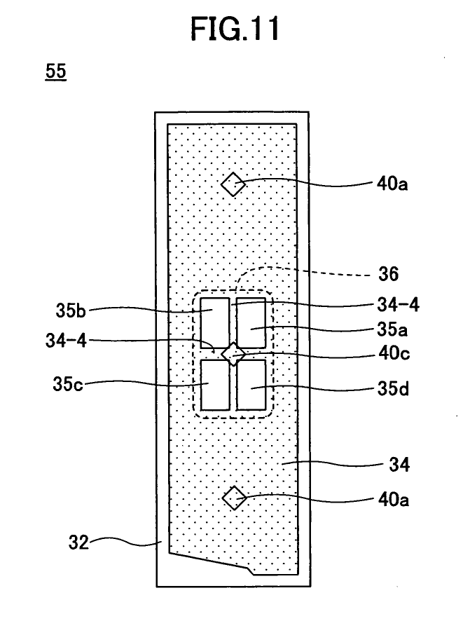

FIG. 10 is a plan view of a first variation of the second blue pixel 31B-2. FIG. 11 is a plan view of a second variation of the second blue pixel 31B-2. In FIGS. 10 and 11, the elements corresponding to those described above are referred to by the same numerals, and a description thereof is omitted.

Referring to FIG. 10, a second pixel 50 (whose color may be any of red, green, and blue) as a first variation of the second blue pixel 31B-2 has the same configuration as the second blue pixel 31B-2 shown in FIGS. 7 and 8 except that a colored area 34-3 in which the alignment control projection 40c is disposed and color-free areas 35a and 35b in the reflective part 36 are different in shape. The action and effects of the second pixel 50 are the same as those of the second blue pixel 31B-2.

The second pixel 50 has substantially the same layered structure as the layered structure shown in FIG. 8. Further, in terms of the planar structure of the second pixel 50, the colored area 34-3 is elongated sidewise as shown in FIG. 10. Here, it is assumed that the dimension of the colored area 34-3 in the longitudinal direction of the second pixel 50 is equal to the dimension of the colored area 34-2b of FIG. 7 in the longitudinal direction of the second blue pixel 31B-2. In this case, if the same amount of transparent resin as in the case of FIG. 9C is applied, the surface of the convex part of a transparent resin layer is higher than the surface of the convex part 45-2a of the transparent resin layer 45-2 of (b) of FIG. 9C. This is because a color filter layer in the colored area 34-3 is elongated sidewise so that the transparent resin layer is likely to rise. Accordingly, the dimension of the colored area 34-3 in the longitudinal direction of the second pixel 50 necessary for forming a convex part of a predetermined height can be smaller than the dimension of the colored area 34-2b of FIG. 7 in the longitudinal direction of the second blue pixel 31B-2. As a result, the display of the reflective part 36 becomes more natural, thus resulting in improved quality.

Further, referring to FIG. 11, a second pixel 55 (whose color may be any of red, green, and blue) as a second variation of the second blue pixel 31B-2 has the same configuration as the second pixel 50 shown in FIG. 10 except that a colored area 34-4 in which the alignment control projection 40c is disposed has a crisscross shape and four color-free areas 35a through 35d are formed in the reflective part 36. The action and effects of the second pixel 55 are the same as those of the second pixel 50 shown in FIG. 10.

In the case of the second pixel 55, the colored area 34-4 has a crisscross shape. Therefore, the convex part of a transparent resin layer formed in the process of FIG. 9C is more likely to rise than in the case of the second pixel 50 shown in FIG. 10. Accordingly, the width of each of the vertical and lateral linear parts of the colored area 34-4 can be smaller than the dimension of the colored area 34-3 of FIG. 10 in the longitudinal direction of the second pixel 50. As a result, the display of the reflective part 36 of the second pixel 55 becomes more natural, thus resulting in improved quality.

Further, the color-free areas 35a through 35d of the second pixel 55 are four small areas separated by the colored area 34-4. As a result, as the area of the second pixel 55 becomes greater, colored light and white light are less likely to be observed separately from each other compared with the case of the second blue pixel 31B-2 shown in FIG. 7 and the second pixel 50 shown in FIG. 10. Accordingly, the display of the reflective part 36 of the second pixel 55 becomes more natural, thus resulting in improved quality.

### Second Embodiment

An LCD according to a second embodiment of the present invention, which is a variation of the LCD 10 of the first embodiment, is substantially the same as the LCD 10 except that the cross-sectional structures shown in FIGS. 6 and 8 are different in the LCD of the second embodiment. In the drawings, the elements corresponding to those described above are referred to by the same numerals, and a description thereof is omitted.

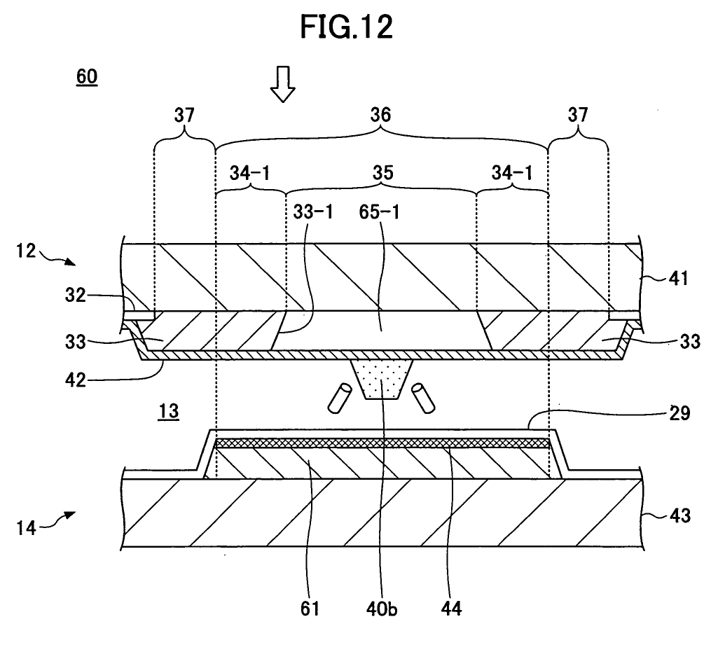

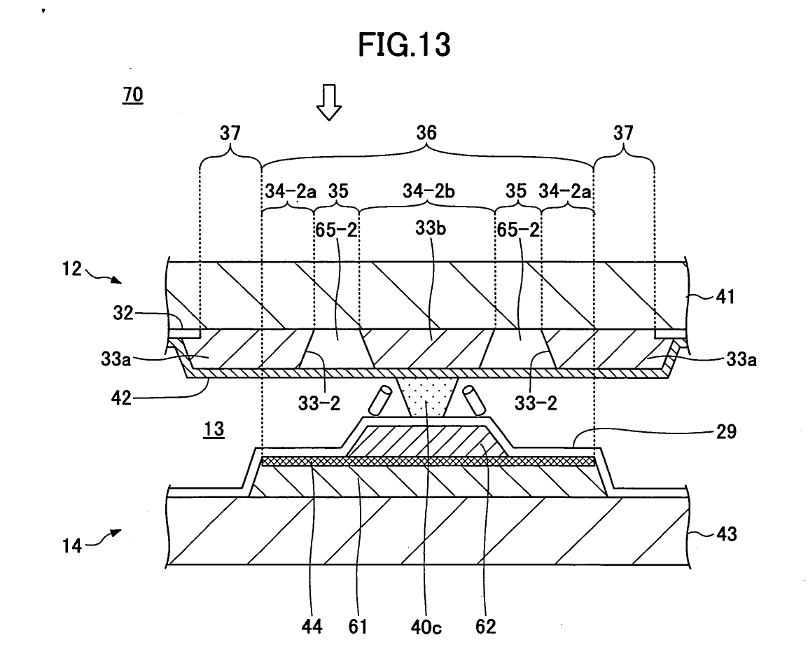

FIG. 12 is a cross-sectional view of part of a first pixel 60 of the LCD according to the second embodiment. FIG. 12 shows a cross-sectional view at the same position as the cross-sectional view taken along the line B-B of FIG. 4. Further, FIG. 13 is a cross-sectional view of part of a second pixel 70 of the LCD according to the second embodiment. FIG. 13 shows a cross-sectional view at the same position as the cross-sectional view taken along the line C-C of FIG. 7.

Referring to FIG. 12, the black matrix layer 32 and the color filter layer 33 are provided under the glass substrate 41 on the CF substrate 12 side of the first pixel 60. The opening 33-1 is provided in the sidewise center part of the color filter layer 33 so as to pass through the color filter layer 33. Further, a transparent resin layer 65-1 equal in thickness to the color filter layer 33 is provided in the opening 33-1. The surface of the color filter layer 33 and the surface of the transparent resin layer 65-1 are formed in substantially the same plane. The alignment control projection 40b is provided on the counter electrode 42 on the surface of the transparent resin layer 65-1.

On the other hand, in the TFT substrate 14, an insulating film 61 is provided on part of the glass substrate 43, and the reflective layer 44 is provided on the insulating film 61. Further, the pixel electrode 29 is provided so as to cover the glass substrate 43 and the reflective layer 44. As in the first embodiment, the reflective layer 44 forms the reflective part 36, and the area outside the reflective part 36 is the transmissive part 37.

In the first pixel 60, the surface of the TFT substrate 14 has a convex shape because of the insulating film 61. In the reflective part 36, the distance between the counter electrode 42 and the pixel electrode 29, that is, the thickness of the liquid crystal layer 13, is 4 μm, for example. The end part of the alignment control projection 40b of the first pixel 60 is out of contact with the pixel electrode 29.

The reflective part 36 includes the colored area 34-1 in which the color filter layer 33 is formed on the surface of the glass substrate 41, and the color-free area 35 in which the transparent resin layer 65-1 is formed on the surface of the glass substrate 41. The area ratio of the colored area 34-1 to the color-free area 35 is substantially the same as in the below-described second pixel 70.

Referring to FIG. 13, the black matrix layer 32 and the color filter layers 33a and 33b are provided under the glass substrate 41 on the CF substrate 12 side of the second pixel 70. The color filter layer 33b is formed in the center part of the second pixel 70. The opening 33-2 is provided around the color filter layer 33b so as to expose the glass substrate 41. Further, a transparent resin layer 65-2 equal in thickness to the color filter layers 33a and 33b is provided in the opening 33-2. The surfaces of the color filter layers 33a and 33b and the surface of the transparent resin layer 65-2 are formed in substantially the same plane. The alignment control projection 40c is provided on the counter electrode 42.

On the other hand, in the TFT substrate 14, the insulating film 61 is provided on part of the glass substrate 43, and the reflective layer 44 is provided on the insulating film 61. Further, a transparent insulating film 62 is provided at a position substantially opposite the alignment control projection 40c on the reflective layer 44. Further, the pixel electrode 29 is provided so as to cover the glass substrate 43, the reflective layer 44, and the transparent insulating film 62. As in the first pixel 60 shown in FIG. 12, the reflective layer 44 forms the reflective part 36, and the area outside the reflective part 36 is the transmissive part 37.

In the second pixel 70, a convex part is formed on the surface of the TFT substrate 14 because of the insulating film 61 and the transparent insulating film 62. This convex part is higher than that of the first pixel 60 shown in FIG. 12 by the thickness of the transparent insulating film 62. As a result, the end part of the alignment control projection 40c of the second pixel 70 comes into contact with the pixel electrode 29, so that the alignment control projection 40c functions as a spacer to control the gap between the CF substrate 12 and the TFT substrate 14. The action and effects of the alignment control projection 40c of FIG. 13 are the same as those of the alignment control projection 40c shown in FIG. 8.

The reflective part 36 includes the colored areas 34-2a and 34-2b in which the color filter layers 33a and 33b, respectively, are formed on the surface of the glass substrate 41, and the color-free area 35 in which the transparent resin layer 65-2 is formed. The area ratio of the colored area 34-2a and the colored area 34-2b together to the color-free area 35 is substantially the same as the area ratio of the colored area 34-1 to the color-free area 35 of the first pixel 60 shown in FIG. 12.

A cross-sectional view of each of the first and second pixels 60 and 70 including an alignment control projection formed in the transmissive part 37 is equal to the cross-sectional view shown in FIG. 5 of the first embodiment, and a description thereof is omitted.

According to the LCD according to the second embodiment, the alignment control projection 40c provided in the reflective part 36 of a pixel also functions as a spacer to control the gap between the CF substrate 12 and the TFT substrate 14. At the same time, since the alignment control projection 40c can control the alignment of its surrounding liquid crystal, the reflective part 36 has good display characteristics. As a result, it is possible to establish agreement in display characteristics such as color density and transmissivity with a pixel of the same color in which the reflective part 36 is provided with the alignment control projection 40b, which does not function as a spacer. In consequence, it is possible to make these characteristics uniform in a display area.

Further, according to the LCD according to the second embodiment, the alignment control projections 40b and 40c are formed on the counter electrode 42, which serves as a substantially single plane. Accordingly, in the process of forming the alignment control projections 40b and 40c, it is easy to perform focusing in exposing the pattern of the alignment control projections 40b and 40c. Further, since defocus in the direction of depth of focus is controlled, the alignment control projections 40b and 40c of substantially the same size can be easily formed.

According to one embodiment of the present invention, an alignment control projection provided in a reflective part functions as a spacer. Therefore, it is possible to retain a predetermined distance between a first substrate and a second substrate. Further, the alignment control projection controls the alignment of its surrounding liquid crystal molecules. Accordingly, it is possible to maintain the display quality of the reflective part. Further, by appropriately selecting a pixel in which such an alignment control projection with the spacer function is to be formed, it is possible to prevent so-called foaming in a low-temperature environment and the problem of variations due to gravity.

According to one embodiment of the present invention, in the process of selectively forming a color filter layer, the color filter layer is left in a position in a reflective part in which position an alignment control projection to function as a spacer is to be formed. As a result, a convex part is formed on the surface of a transparent resin layer covering the color filter layer. By forming the alignment control projection on the convex part, the end part of the alignment control projection protrudes to come into contact with a first substrate. Accordingly, it is possible to omit the process of forming a spacer without providing a new process. Accordingly, it is possible to reduce the number of processes and to simplify the manufacturing process, so that it is possible to reduce manufacturing costs.

Further, whether to provide the alignment control projection to function as a spacer in the reflective part may be determined by changing the pattern of a single mask in the process of selectively forming the color filter layer. Therefore, it is possible to easily change the proportion of alignment control projections to function as a spacer to the alignment control projections. Accordingly, in a design change accompanied by a change in the proportion of alignment control projections to function as a spacer, it is possible to reduce the time and cost necessary for the design change, so that it is possible to reduce manufacturing costs.

Thus, according to embodiments of the present invention, it is possible to provide a transflective LCD having a projection to function as a spacer and to control the alignment of liquid crystal molecules in a pixel, and a method of manufacturing the same.

The present invention is not limited to the specifically disclosed embodiments, and variations and modifications may be made without departing from the scope of the present invention.

For example, in the first and second embodiments, the reflective part 36 is provided in the center part of a pixel. Alternatively, the reflective part 36 may be provided in a part offset from the center part toward either longitudinal end of the pixel, that is, at either an upper or lower part of the pixel in the drawings. However, in light of display quality, it is preferable to provide the reflective part 36 in the substantially center part of the pixel. Further, the above description is given of the case where three alignment control projections are provided in one pixel. However, the number of alignment control projections in one pixel is not limited to three, and may be one, two, or more than three. Further, the above description is given of the case where the single reflective part 36 is formed in one pixel. However, the number of reflective parts in one pixel is not limited to one, and may be two or more.

The present application is based on Japanese Priority Patent Application No. 2005-157586, filed on May 30, 2005, the entire contents of which are hereby incorporated by reference.

What is claimed is:

1. A liquid crystal display, comprising:
a first substrate having a reflective layer;
a second substrate having a plurality of pixels formed thereon, the pixels each having a color filter layer; and
a liquid crystal layer sandwiched between the first and second substrates with a predetermined distance between the first and second substrates,
wherein each of the pixels includes a reflective part to reflect light entering from a side of the second substrate by the reflective layer and a transmissive part to transmit light from a side of the first substrate facing away from the second substrate;
an alignment control projection to control alignment of liquid crystal molecules is provided in the reflective part of each of the pixels; and
the alignment control projection in the reflective part functions as a spacer to control the predetermined distance between the first and second substrates in at least one of the pixels.

2. The liquid crystal display as claimed in claim 1, wherein:
the alignment control projections are provided on a surface of the second substrate facing toward the liquid crystal layer; and
the pixels include a first pixel and a second pixel, the first pixel having an end part of the alignment control projection thereof out of contact with the first substrate, the second pixel having an end part of the alignment control projection thereof in contact with the first substrate and causing the alignment control projection thereof to serve as the spacer.

3. The liquid crystal display as claimed in claim 2, wherein:
the alignment control projection of the first pixel is provided on a transparent resin layer formed on the surface of the second substrate facing toward the liquid crystal layer; and
the alignment control projection of the second pixel is formed on a convex body of the transparent resin layer with a color filter layer being provided between the surface of the second substrate facing toward the liquid crystal layer and the transparent resin layer.

4. The liquid crystal display as claimed in claim 2, wherein:
a convex body is provided on the first substrate so as to oppose the alignment control projection of the second pixel; and
the end part of the alignment control projection of the second pixel is in contact with the convex body.

5. The liquid crystal display as claimed in claim 2, wherein:
the reflective part includes a colored area having at least the color filter layer on a transparent substrate of the second substrate and a color-free area having at least a transparent resin layer on the transparent substrate; and
the second pixel is substantially equal to the first pixel in an area ratio of the colored area to the color-free area.

6. A method of manufacturing a liquid crystal display, the liquid crystal display including a first substrate having a reflective layer; a second substrate having a plurality of pixels formed thereon, the pixels each having a color filter layer; and a liquid crystal layer sandwiched between the first and second substrates with a predetermined distance between the first and second substrates, wherein each of the pixels includes a reflective part to reflect light entering from a side of the second substrate by the reflective layer and a transmissive part to transmit light from a side of the first substrate facing away from the second substrate, the method comprising the steps of:
(a) selectively forming the color filter layer on a transparent substrate;
(b) selectively forming a transparent resin layer covering the color filter layer; and
(c) forming an alignment control projection on the transparent resin layer,
wherein said step (a) forms the color filter layer in an area where the alignment control projection is to be formed in the reflective part in at least one of the pixels; and
said step (c) forms the alignment control projection on a surface of the transparent resin layer on which a convex part is caused to be formed by the color filter layer.
